(19) United States
(12) Patent Application Publication
(10) Pub. No.: US 2008/0239925 A1
(43) Pub. Date: Oct. 2, 2008

(54) Compact Switchable Optical Unit

(75) Inventors: Stein Kuiper, Vught (NL); Bernardus H.W. Hendriks, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,332

(22) PCT Filed: Mar. 24, 2005
(86) PCT No.: PCT/IB2005/051016

§ 371 Date: Sep. 26, 2006

(30) Foreign Application Priority Data
Mar. 30, 2004 (GB) 0407233.6

(51) Int. Cl. G11B 7/135; G02B 3/14; G02B 3/12

(52) U.S. Cl. 369/112.02; 359/666

(57) ABSTRACT

A switchable optical unit, capable of controlling a beam of radiation (b) passing through an optically active portion (8) of the unit, comprises a fluid chamber (10) including an electrically conductive liquid (18), which chamber comprises a pair of first electrodes (20,22) fixed to the chamber inner walls (12,14) at the position of the optically active portion and second electrode means (24) fixed to inner walls of the chamber outside the optically active portion and a third electrode (28) connected to the conductive liquid. By applying a voltage (V) to the first electrodes and the second electrode means, respectively the conductive liquid can be moved in and out the optically active portion so that the unit (1) is switched between a least two discrete states.

The invention relates to a switchable optical unit capable of controlling a beam of radiation passing through an optically active portion of the unit, which unit comprises a chamber and an electrically conducting liquid contained in the chamber and having an index of refraction different from that of its surroundings, the chamber being provided with an electrode configuration, wherein application of a voltage, from a voltage control system, to electrodes, causes movement of the said liquid.

The invention also relates to a camera system and to an optical head for scanning an optical record carrier comprising such a switchable optical unit.

International patent application WO 03/069380 describes a lens element and a lens system which focal distance can be varied comprising such an optical unit. The variable focus lens system comprises a cylindrical fluid chamber having a cylinder wall, the fluid chamber including a first fluid and a second fluid, which fluids are non-miscible. The first and second fluid have different indices of refraction, so that the interface between the fluids, which interface has the form of a meniscus, forms a refractive surface, i.e. a surface that changes the vergence (convergence or divergence) of a radiation beam passing through the surface. A first electrode is arranged on the inside of the cylinder wall and the inside of this electrode is coated with a fluid contact layer. A second electrode is arranged at an end face of the cylinder and this electrode is in contact with the second fluid. Since the fluid contact layer has a wettability by the second fluid, which varies in dependency of the voltage applied between the first and the second electrode, varying this voltage can change the shape of the interface meniscus. In this way a lens element is obtained, the focal length of which can be varied over a large range, for example the meniscus shape can be varied between concave and convex, provided that the voltage between the electrodes is sufficient large, for example of the order of 100 Volts. A concave meniscus means that the lens element has negative optical power and a convex meniscus means that the lens element has positive optical power.

To achieve that the lens element or lens system functions independently of orientation, i.e. without dependence on gravitational effects between the two liquids, the liquids should have equal density. The difference between the indices of refraction of such liquids is limited. Since this difference and the curvature of the meniscus determine the refractive power of the meniscus a relative large voltage should be applied between the electrodes to achieve that the lens element has sufficient power or a sufficient power range. Such large voltage results in a too large electrical field strength in an insulating layer between the cylindrical electrode and the fluid contact layer and in charging of the fluid contact layer, and hence degradation of this layer.

Moreover, since the two liquids fill up the liquid chamber, an expansion chamber is needed to accommodate volume changes due to thermal expansion of the fluids. Such an expansion chamber requires additional space in the lens system or apparatus wherein the lens element is to be used.

In a number of applications of the optical device it is not necessary to vary the focal length over a certain range, but it suffices to switch the focal length between two values, for example between a Tele configuration or -mode and a Macro mode. For such an application a device could be used that comprises a liquid chamber filled with two liquids having different indices of refraction and wherein the liquids are switched in and out the optically active portion of the device, i.e. the portion through which a radiation beam passes, by electrowetting. This requires a liquid circulation system to convey one of the liquids from one end of the liquid chamber to the other end of the chamber so that the other liquid can be moved in the chamber. Such a circulation system is a relative complex system and requires additional space and an optical system comprising such a circulation system is not suitable for small and consumer apparatuses.

It is an object of the present invention to provide a switchable optical unit as defined in the opening paragraph that has a simple and compact construction, can be driven by a relative low voltage and opens the way to new applications. This unit is characterized in that the electrode configuration comprises a pair of first, central, electrodes fixed to the inner walls of the chamber at the position of the optically active portion, second electrode means fixed to the inner walls of the chamber at positions outside the optically active portion and a third electrode in contact with the liquid and continuously connected to a first output of a voltage source, a second output of which is connected in a first mode to at least one of the first electrodes and in a second mode to the second electrode means.

If the second output of the voltage source is connected to the pair of first electrodes, the conductive liquid is attracted by the first pair of electrodes so that the liquid is positioned in the optically active portion of the device. In case the liquid chamber is arranged between refractive surfaces of a lens system, the unit then has a first optical power, which is determined by the refractive index of the conductive liquid and the curvature of the lens surfaces. When the second output of the voltage source is connected to the second electrode means, the conductive liquid is attracted by the second electrode means so that the liquid is positioned outside the optically active portion. The device then has a second optical power, which is determined by the refractive index of a medium that has replaced the polar liquid. As will be explained later, this medium may be of different natures.

The construction of the unit and the amount of conductive liquid should be such that the liquid always overlaps those end portions of the first electrodes and of the second electrode means, which are in line with each other. In this way it is ensured that the conductive liquid always experiences the electrowetting force generated by the electrode that is activated, i.e. to which a voltage is supplied.

A lens system the optical power of which can be switched between two values by means of alternately moving a first liquid and a second liquid in the optically active zone is known per se from U.S. Pat. No. 4,477,158. However, in this system the liquids are moved by tilting the lens system, which may form part of spectacle lenses or contact lenses and a complicated construction of liquid channels, amongst others in the earpiece of the spectacle, is needed to realise such movement.

The second electrode means may comprise two flat ring-shaped electrodes arranged in the same planes as the first electrode pair.

However, a preferred embodiment of the switchable optical unit is characterized in that the second electrode means is constituted by one annular electrode having a U-shaped cross-section.

This electrode is composed of two flat ring-shaped portions and a cylindrical portion connecting the ring-shaped portions and allows exerting more force on the conductive liquid.

Preferably, the unit is characterized in that the interior of the chamber exposed to the conductive liquid is coated with an insulating hydrophobic layer.

This measure prevents that liquid sticks to the inner wall at positions where it should be removed.

The switchable optical unit is further characterized in that the chamber comprises a medium, which has an index of refraction different from that of the conductive liquid.

This medium may be of different nature. A first embodiment of the unit is characterized in that the medium is a liquid.

A second embodiment of the unit is characterized in that the medium is a gas. A third embodiment of the unit is characterized in that the liquid-less portions of the chamber are at vacuum.

In practice these portions will contain vapour of the conductive liquid. In case the unit forms part of a lens system, this allows increasing the difference between the optical powers in the first mode and in the second mode respectively of the system. This is due to the fact that the difference between the refractive index of the conductive liquid and a gas may be much larger than such difference between the first conductive and another liquid.

The walls of the liquid chamber situated in the optically active portion of the device may show different shapes or configurations, depending on the specific applications of the switchable optical unit. A first class of embodiments of the unit, which comprises at least one lens element, is characterized in that at least one chamber wall situated in the optically active portion is constituted by a refractive lens surface.

A second embodiment of the first class is characterized in that each of two opposite chamber walls situated in the optically active portion is constituted by a refractive lens surface.

The optical unit of the first class of embodiments is fixed to a conventional lens element or embedded in a conventional lens system and used for switching the optical power of the lens element or lens system between two values.

A third, and preferred, embodiment of the first class is characterized in that at least one of the refractive lens surfaces is an aspherical surface.

An aspherical surface is understood to mean a surface, which basic shape is spherical or another regular shape, but which real shape shows small deviations, which allow to correct for spherical aberrations introduced by the basic surface shape. Using aspherical surfaces in optical systems allows minimising the number of lens elements in such lens systems, because additional lens elements for correcting aberrations of other lens elements are no longer needed. In the present optical unit one or both chamber walls and/or one or more other lens surfaces may have an aspherical shape.

A second class of embodiments of the switchable optical unit is characterized in that at least one chamber wall situated in the optical active portion is provided with a phase structure.

A phase structure is understood to mean a surface structure composed of surface portions at different levels, which structure introduces phase shifts in beam portions passing through different surface portions. Such a phase structure can be used for several functions.

A first embodiment of the second class is characterized in that the phase structure in a non-periodical structure, which renders the unit to a wavefront-modifying unit.

Such a unit may, for example be used in an optical head for scanning optical record carriers of different formats to adapt the objective system for scanning beams having different wavelength.

A second embodiment of the second class is, characterized in that the phase structure is a periodical structure.

Also this unit may be used in the optical head for several purposes.

The switchable optical unit may further be characterized in that the voltage control system is arranged to supply a voltage to the first electrodes individually.

By activating firstly one of the first electrodes and thereafter activating the other first electrode, the flow of the first fluid and the second medium to and from the central portion can be improved. In case each of the two main walls of the chamber is provided with an optical function, for example a grating- or lens function, these functions can be switched independently of each other. This increases the freedom of design of the optical system of which the switchable unit forms part.

The switchable unit may be further characterized in that the index of refraction of the first liquid is equal to that of the optically relevant material of the chamber wall.

The optically relevant material is the lens material, in case the chamber is included in a lens system, or the material wherein a phase structure is configured. The electrodes and the insulating layer are such thin that they have no effect on the radiation. If in this unit the first liquid is positioned in the optically active portion there is no difference between the refractive index of the liquid and that of said material thus no optical discontinuity and the optical function, for example a grating function, is no longer active. It becomes active when the second medium is positioned to the chamber wall. In this way the grating function or other optical function can be switched off and on.

The switchable optical unit may be used in a miniature camera to provide such a camera with a Tele and Macro mode. The camera can be built-in in a hand held apparatus, like a mobile phone.

Another main application of the switchable optical unit is an optical head for scanning an information layer and comprising a radiation source unit for supplying a scanning beam, an objective system for focusing the scanning beam to a scanning spot in the information layer and a radiation-sensitive detection unit for converting scanning beam radiation from the information layer in electrical signals. The invention may be implemented in such an optical head as a switchable grating that can threaten radiation beams of different wavelength in the same way. These beams may be a write beam and a read beam from a same laser that can be switched between write level and read level. These beams may also be two or three beams having substantially different wavelengths, which beams are used in an optical head for scanning information layers in record carriers of two or three different types.

In the two- or three-beams optical head the switchable optical unit may also be used as a wavefront modifier to render the objective lens system suitable for correct focusing each of the beams to a scanning spot in the information layer of the associated type of record carrier.

These and other aspects of the invention will be apparent from and will be elucidated, by way of non-limitative example, with reference to the embodiments described hereinafter. In the drawings:

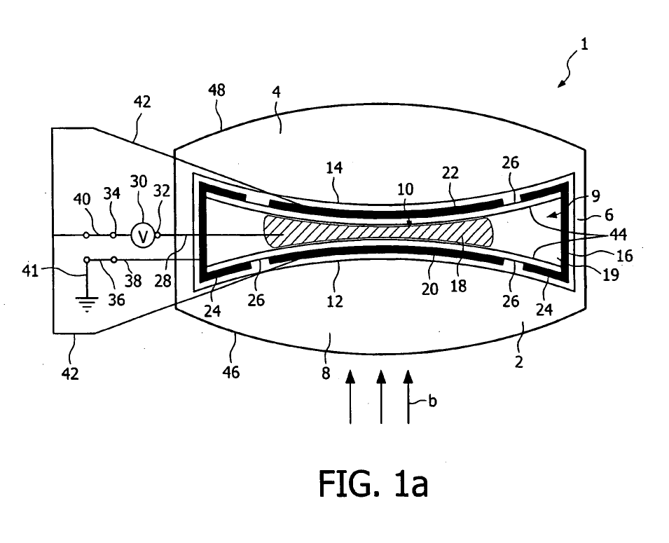

FIGS. 1a and 1b show a cross-section of a switchable lens system unit according to the invention in a first mode and in a second mode, respectively;

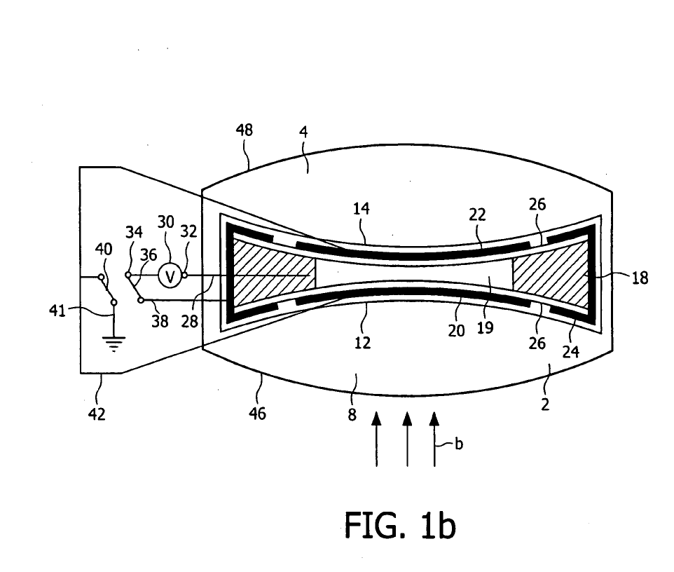

FIGS. 2a and 2b show a cross-section of a switchable binary grating unit according to the invention in a first mode and in a second mode, respectively;

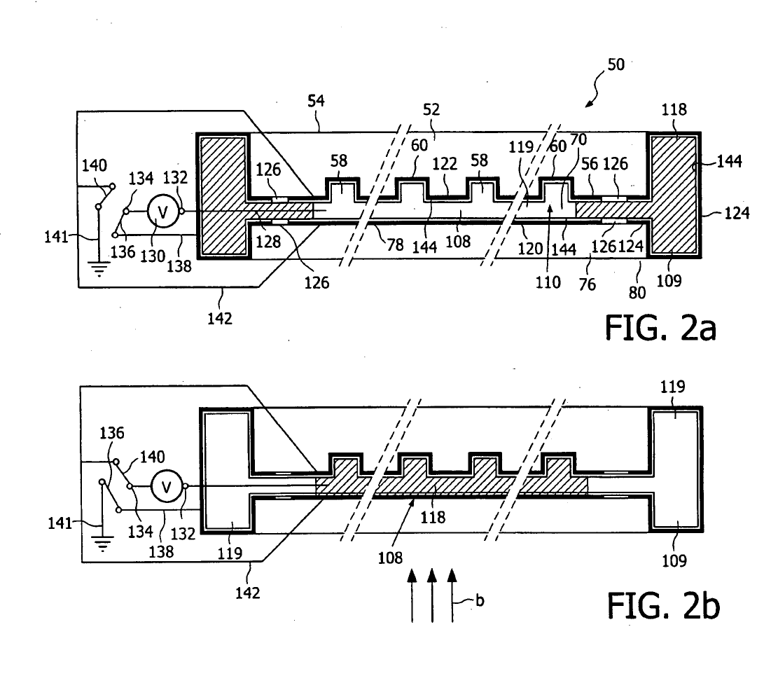

FIGS. 3a and 3b show a cross-section of a small portion of a switchable non-periodic-phase-structure unit according to the invention in a first mode and in second mode respectively;

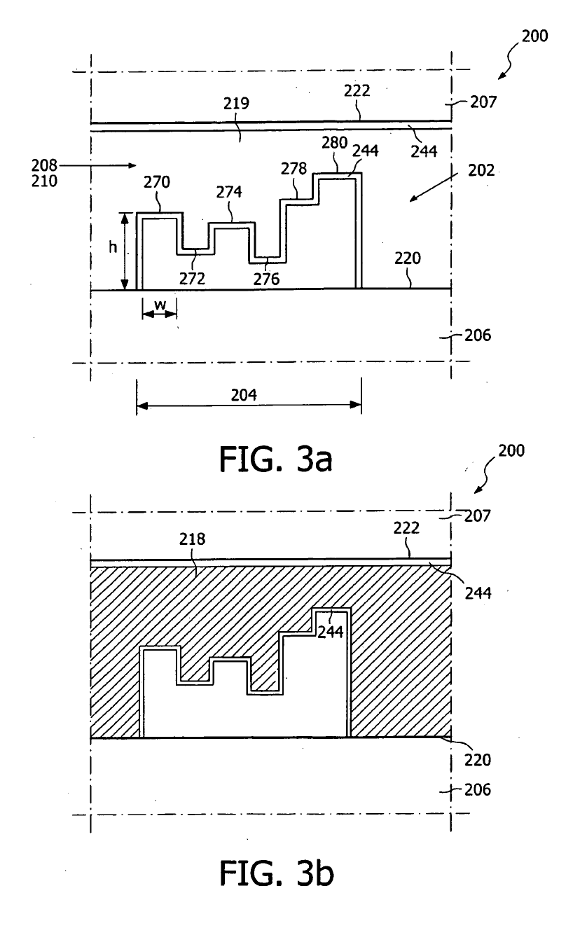

FIG. 4 shows the principle of a miniature camera including a switchable lens system;

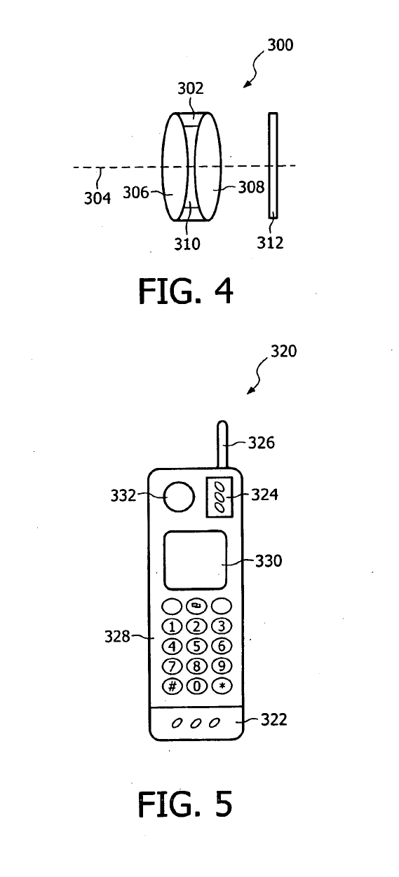

FIG. 5 shows a mobile phone including such a miniature camera, and

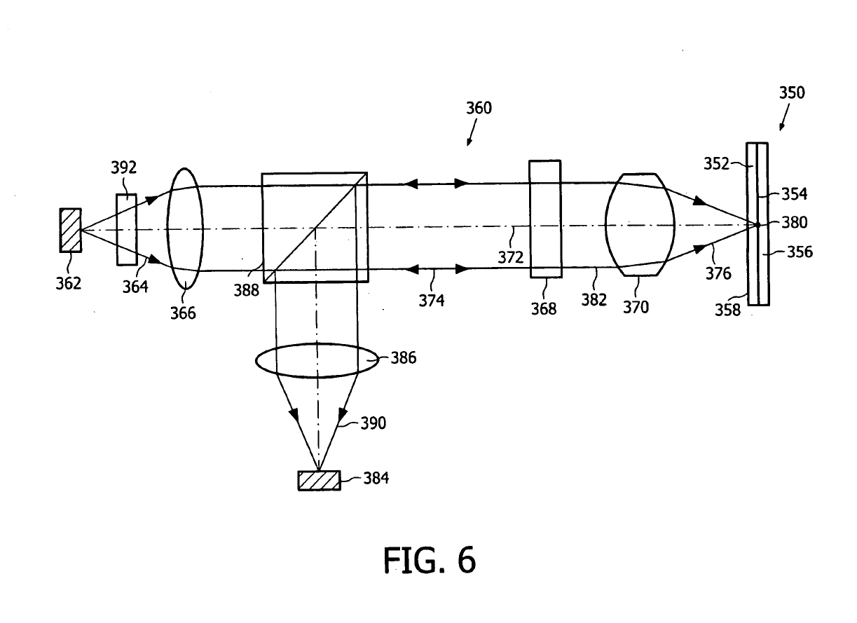

FIG. 6 shows an optical head wherein on or more switchable optical units according to the invention can be used.

FIGS. 1a and 1b show a cross-section of an embodiment wherein the device according to the invention is integrated in a lens system 1. The lens system is composed of two solid lens elements 2 and 4, which are cemented together at their border portion 6. The lens elements may be made of glass or transparent plastics. Between the lens elements a liquid chamber 10 is present, which is closed by the inner walls of the lens elements, so by the refractive surface 12 of lens element 2, the refractive surface 14 of lens element 4 and the common inner wall 16 of the lens elements. The chamber is partially filled with an electrically conductive or polar liquid 18, for example salted water, hereinafter also called first liquid. The remaining space in the chamber is filled with a second medium 19 which may be another, non-conducting liquid, for example an oil. The second medium may also be a gas. The remaining space of the chamber may also be at vacuum, which in practice will mean that it comprises vapour of the first liquid. The second medium has an index of refraction different from the index of refraction of the polar liquid.

On the central portion of the refractive surfaces 12 and 14 circular first electrodes 20 and 22 are arranged. These electrodes define the optically active portion 8 of the lens system; i.e. the portion that passes an incident radiation beam, which wave front is to be changed by the lens system. These electrodes, i.e. the pair of first electrodes, are made of an electrically conductive transparent material, for example ITO (indium tin oxide). Second electrode means 24 are arranged at the side portion 9 of the chamber, i.e. the portion outside the optically active portion 8. The ends of these electrode means are separated from the ends of the first electrodes by a gap 26. The electrode means 24 need not to be transparent and can be made of a metallic material. A third electrode 28 is in direct contact with the polar liquid. This electrode is permanently connected to a first output 32 of a voltage source 30. The second output 34 of this source can be connected to either the pair of first electrodes, via the switch 40 and the conductor 42, or the second electrode means, via the switch 36 and the conductor 38.

The inner side of the electrodes, i.e. the side facing the liquid chamber is covered with a transparent electrically insulating layer formed for example of parylene. The inner side of this layer and the openings 26 between the ends of the first electrodes and the ends of the second electrode means is coated with a hydrophobic layer, which is transparent and formed for example of Teflon™ AF 1600 produced by DuPont™. This layer prevents that liquid sticks anywhere to the chamber wall. As shown in FIGS. 1a and 1b, instead of two layers, also a single layer 44, which is both insulating and hydrophobic, may be used.

The pair of first electrodes 20,22, the second electrode means 24 and the third electrode 28 form a configuration of electrowetting electrodes which together with the voltage control system 30, 36, 38,40, 42 form a fluid system switch. This fluid system acts upon the described fluid system comprising the polar fluid 18 and the second medium in order to switch between first and second discrete states of the switchable unit

In the first discrete state of the unit, shown in FIG. 1a, the switch 40 connects the second output of the voltage source to the pair of first electrodes 20 and 22 so that a voltage V of an appropriate value is applied across each of the first electrodes 20,22 and the common, third electrode 28. The applied voltage V provides an electrowetting force such that the switchable unit adopts the first state wherein the polar liquid 18 moves to fill the space between the first electrodes 20 and 22, i.e. the optically active portion. As a result of the applied voltage V, the hydrophobic layer 44 of the chamber 10 becomes at least relatively hydrophilic in nature, thus aiding the preference of the polar liquid 18 to fill the chamber space between the first electrodes, i.e. the optically active portion. The polar liquid 18 moving towards the space between the first electrodes displaces the second medium 19 towards the chamber space between the second electrode means 24, i.e. the side chamber space 9. If the switchable unit is in the first discrete stage the switch 36 connects the second electrode means to the ground electrode 41 so that no voltage is applied to the second electrowetting electrode means 24 and the layer 44 at the position of this electrode means remains highly hydrophobic.

In order to switch from the first discrete state to the second discrete state, switch 36 is moved to the second output 34 of the voltage source and switch 40 is moved to the ground electrode 41 so that a voltage of an appropriate value, for example V, is applied across the second electrode means 24 and the common, third electrode 28, whilst no voltage is applied to the first electrodes 20, 22.

The switchable optical unit is now in the second discrete state, in which the first liquid 18 fills the chamber space between the second electrode means 24 as a result of electrowetting forces provided by the voltage applied to this electrode means. Due to the applied voltage the hydrophobic layer 42 at the position of the electrode means 24 is now at least relatively hydrophilic and tends to attract the first liquid 18. This liquid moves to fill the chamber space is enclosed by the second electrode means 24 and displaces the second medium 19 towards the chamber space between the first electrodes 20 and 22, i.e. towards the optically active portion of the unit. Since no voltage is applied to these electrodes, the layer 42 at the position of these electrodes remains highly hydrophobic.

Movement of the polar liquid in and out the optically active portion of the lens system 1 means that the refractive index in the space between the two refractive surfaces 12 and 14 is switched between two values. Since this refractive index, together with the curvatures of the refractive surfaces determine the optical power of the lens sub-system formed by the refractive surfaces 12 and 14 and the chamber, the optical power of this lens sub-system, and thus of the whole lens system can be switched between two values by switching the voltage from the first electrode pair to the second electrode means and vice versa.

The difference between the two power values depends on the difference between the refractive indices of the first liquid 18 and the other medium 19 and is not influenced by gravitational forces, as is the case in known electrowetting lenses. The density of the polar liquid and the medium 19 thus need not to be matched. This provides the advantage that the difference between the refractive indices of the two media can be freely chosen and adapted to the envisaged application. The second medium may be also a liquid; for example an oil based electrically insulating liquid, such as silicone oil. The second medium may also be a gas, having in general a considerable lower refractive index than a liquid. In principle the space in the chamber that is not occupied by the polar liquid may also be at vacuum. In practice this space will be filled with vapour of the polar liquid, which vapour has a refractive index close to 1. For example, if the polar liquid is water with a tungsten salt dissolved in it, its refractive index may be larger than 1.5. The difference between the refractive index of this polar liquid and that of its vapour thus may be larger than 0,5, which is considerably larger that the difference that can be achieved with the liquids in known electrowetting lenses.

The focal length of a lens system provided with such embodiment of the is present switchable optical unit may be switched between two largely different values, which allows using the unit to switch a lens system between a Tele mode having a small focal length and a Wide, or Macro-, mode having a large focal length.

For sake of clarity, in FIG. 1a some space has been left open between the first electrodes 20, 22 and the polar liquid 18, but in reality the liquid 18 fills the whole space between these electrodes. Since electrowetting forces are present at any area of an electrode to which a voltage is applied, the first liquid will cover the whole surface of the insulating layer overlying this electrode. In this a better liquid covering is achieved than would be possible in a system wherein liquids are displaced by means of pumping. This is a great advantage of the switchable optical unit of the invention.

As shown in FIGS. 1a and 1b the amount of the first liquid 18 and the width of the gap 26 between the ends first electrodes and the ends of the second electrode means 24 are chosen such that in case the first liquid 18 is positioned in the optically active portion 8, it still covers the border of the second electrode means 24. In case this liquid is positioned outside the portion 8 it still covers the borders of the first electrode pair. In this way it is achieved that the, during each transition between the first and second discrete states of the unit, the polar liquid 18 always feels the electrowetting force of a newly activated electrode so that it starts to move.

The movement of the polar liquid and the second medium towards and from the first and second electrodes and the mutual displacement of the liquid and the medium can be improved by activating the first electrodes 20 and 22 not simultaneously, as is the case in FIGS. 1a and 1b, but one after the other. For example, if the polar liquid has to move to the optically active portion of the unit, first a voltage is applied to the electrode 20 so that first the space above this electrode is filled with the polar liquid and the second medium is moved from this space to the side portion of the chamber. Thereafter the voltage is applied to the electrode 22 so that also the space below this electrode is filled with the polar liquid and the second medium is moved from this space to the side portion of the chamber. The configuration of electronic switches needed for such time-sequential switching of the first electrodes 20 and 22 can easily be designed by the person skilled in the art. If circumstances require so, also portions of the second electrode means can be activated one after the other.

The second electrode means may be constituted by two flat ring-shaped electrodes. Preferably the side of the chamber's inner wall is also covered with electrode material, which connects these electrodes, such that one ring-shaped electrode having a U-shaped cross-section is obtained. In this way the surface of the second electrode means can be enlarged and thus its functionality increased.

FIGS. 1a and 1b show a lens system having two solid lens elements for converging a radiation beam b, which is represented as a parallel beam, but may also be a beam that is already convergent and should be made more convergent. The switchable optical device may also be used in a lens system that has only one lens element or in a system having more than two lens elements. The switchable optical device may also be combined with a divergent lens system having one or by more lens elements.

One or more refractive surfaces of a lens system comprising the switchable optical device may be aspherical. An aspherical surface allows correction of spherical aberrations introduced by a lens surface having spherical surfaces so that no additional lens elements are needed for such correction. In the lens system of FIGS. 1a and 1b one or both of the inner lens surfaces 12 and 14 and/or one or both of the outer lens surfaces 44 and 46 may be aspherical. The specific design of a lens system determines which and how many refractive surfaces of that system should be aspherical.

The principle of the present invention can not only be used to switch the refractive power of a lens element between two values, but may be used also to switch the function of other optical elements, such as a diffraction grating, which has a periodic phase structure, or an element that has a non-periodic phase structure. An element having a phase structure comprises surface portions at two or more levels and such element introduces a corresponding number of different phase shifts in an incident radiation beam.

FIGS. 2a and 2b show a cross-sectional view of a binary grating, i.e. a grating having its surface portions arranged at two levels, which grating can be switched according to the invention. The grating unit 50 comprises a transparent substrate 52 having two main surfaces 54 and 56. Surface 56 is provided with grating strips 58 in the form of groves, by means of well-known techniques. The groves 58 alternate with intermediate grating strips 60 at the surface. The grooved surface forms one wall of a central portion 108, i.e. the optically active portion, of a liquid chamber 110, which comprises also a side chamber portion 109. A transparent layer 76 having an upper surface 78 and a lower surface 80 forms the other central wall of the chamber. The chamber 110 comprises a polar liquid 118 and a second medium 119, which may be a second fluid, a gas or vapour of the polar liquid.

With exception of the grating structure and the curvatures of the main chamber walls, the embodiment shown in FIGS. 2a and 2b has the same construction as that shown in FIGS. 1a and 1b. Elements of the embodiment of FIGS. 2a and 2b, which are similar to elements of FIGS. 1a and 1b have the same reference numerals, each numeral being incremented by 100. In the grating unit of FIGS. 2a and 2b the first liquid 118 and the second medium 119 are displaced from the central portion 108 to the side portion 109 of the liquid chamber 110 and vice versa in the same way and by the same means as in the lens system of FIGS. 1a and 1b. In FIG. 2a the polar liquid 18 is positioned outside the optically active portion 108 so that the unit is in the same state as the unit shown in FIG. 1b. In FIG. 2b the polar liquid is positioned in the active portion so that the unit is in the same state as the unit shown in FIG. 1a.

In the first discrete state of the switchable grating unit, shown in FIG. 2a, the voltage source 130 is connected, via switch 136 and conductor 138, to the second electrode means 124. In this state, due to the electrowetting forces of the electrode means 124 the polar liquid 118 is positioned in the side portion 109 of the chamber, which side portion has an insulating inner layer 144 that has become hydrophilic. In this state the first electrodes 120 and 122 are connected, via switch 140 and the conductor 142 to the ground electrode 141. The second medium 119 is now positioned between the first electrodes.

In the second discrete state of the switchable grating unit, shown in FIG. 2b, the voltage source is connected, via switch 140 and conductor 142, to the first electrodes 120 and 122. In this state, due to the electrowetting forces of the first electrodes, the polar liquid is positioned between these electrodes. In this state the second electrode means are connected, via switch 136 and conductor 138 to the ground electrode. The second medium is now positioned in the side portion 109 of the chamber.

Since in the first and second state of the switchable grating unit the grating groves are filled with media having different refractive indices, the optical depth of the groves, i.e. the product of the geometrical depth and the refractive index, is different in the two states. This allows, for example, using the grating to perform the same grating function for two radiation beams having different wavelengths, whereby for a first wavelength the grating unit is in the first state and for a second wavelength the grating is in a second state. Such a grating can be used, for example, in an optical head wherein two laser beams are used to scan different types of record carriers and wherein both beams should be split into three beams.

As an alternative to the liquid chamber geometry shown in FIGS. 1a and 1b, the liquid chamber of FIGS. 2a and 2b has side chamber portions, which are enlarged in the direction of propagation of the beam b. This measure allows decreasing the size of the switchable unit in the direction transverse to the propagation direction, whilst still having sufficient space available for containing the polar liquid 118 or the second medium that should not be in the optically active portion of the switchable unit. The chamber geometry of FIGS. 2a and 2b can also be used in the lens system of FIGS. 1a and 1b and is especially preferred if the lens surfaces, which form the walls of the chamber, are concave surfaces, instead of the convex surfaces shown in FIGS. 1a and 1b.

It may be difficult to fill a phase grating structure with a liquid or to empty it, because it comprises vertical walls, i.e. walls extending in a direction perpendicular to flow direction of the liquid and its dimensions, i.e. depth and width of the groves are small. The present switchable unit solves this problem, because the electrowetting force used for displacing the liquid is present all over the surface, thus also at the vertical walls, of the grating structure. This is a great advantage of the unit over liquid switching systems wherein liquids are moved by means of pumping.

The switchable optical unit may also comprise a non-periodic phase structure. The paper: “Application of non periodic phase structures in optical systems” in Applied Optics/Vol. 40, No. 35/2001 describes non-periodic stepped phase structures to correct various parameter-dependent wave front aberrations in optical systems, for example optical heads for scanning optical record carriers. In general such a phase structure is a stepped structure that differs from a binary grating in that it shows more than two steps (levels), is non-periodic and has relatively wide zones. The difference in optical paths between two subsequent steps may be any value and many vary in any way throughout the structure. This class of phase structures allows a great degree of freedom in design. Moreover, the annular areas forming this non-periodic pattern can be relatively wide which improves the manufacturability.

The previous filed unpublished PCT patent application IB2003/004030 discloses the combination of a non-periodic phase structure with a switchable fluid system using electrowetting forces, which allows effectively switching the phase structure between two different discrete states in order to provide different wave front modifications in a beam passing through it. This switchable fluid system uses a fluid guide, which is arranged outside the liquid chamber and connected to the chamber via two opposite openings in the chamber wall, to move a first and second liquid in and out the liquid chamber. According to the present invention this fluid system can advantageously be replaced by the fluid system which does not have a fluid guide, but only a fluid chamber and an appropriate electrode configuration as described herein above with respects to FIGS. 1a and 1b and FIGS. 2a and 2b.

FIGS. 3a and 3b show a cross-section of a small, central, portion of a switchable device 200 according to the invention having a non-periodic phase structure. Since the phase structure is shown in a very enlarged scale, only one of its zones 204 can be shown. The phase structure is configured in a transparent substrate 206 and comprises a number of such zones, which together form a configuration that can be arranged at the position of the binary grating in FIGS. 2a and 2b. FIGS. 3a and 3b show only the central portion 208 of the fluid chamber 210, portions of the first electrodes 220 and 222 arranged on a first substrate 206 and a second substrate 207, respectively, the first liquid 218 and the second medium 219 of the fluid switching system. The other elements of the switching system are the same as in FIGS. 2a and 2b.

As shown in FIGS. 3a and 3b, each zone of the phase structure comprises six steps, 270, 272, 274, 276, 278 and 280. These sets have the same width w, but different heights h. FIG. 3a shows the switchable unit in a first discrete state wherein no voltage is supplied to the first electrodes 220 and 222. The second medium 219 is positioned between the first electrodes, whilst the first liquid is positioned in the side portion (not shown) of the liquid chamber. FIG. 3b shows the unit in the second discrete state wherein a voltage is supplied to the first electrodes and wherein the polar liquid is positioned between these electrodes, so in the optically active portion of the unit, whilst the second medium is positioned in the side portion of the liquid chamber. In the same way as described for the binary grating in FIGS. 2a and 2b, the optical depth of the steps 270-280 can be switched between two values by switching the polar liquid 218 and the second medium 219 in and out the optically active portion of the unit 200.

The switchable unit with the non-periodical phase structure of FIGS. 3a and 3b may be used for the same purposes as the switchable optical unit described in the unpublished PCT patent application IB2003/004030. The parameters of the phase structure like the width and the different depths of the steps and the ratio of the refractive indices of the polar liquid and the second medium are determined by the specific envisaged purpose of the unit. For these purposes and parameters reference is made to the unpublished PCT patent application IB2003/004030, which, as far as the purposes and related parameters of the phase structure are concerned, is incorporated herein by reference.

A non-periodical phase structure is even more difficult to fill with a liquid or to empty than a binary grating structure so that using the switchable optical unit, described herein, for switching a non-periodical phase structure provides even more advantages than using it for switching a diffraction grating.

As shown in FIGS. 3a and 3b the first electrode 220 need not to be arranged on top of the phase structure, but may also be arranged between the phase structure and the substrate 204. Although FIGS. 3a and 3b show the insulating layer 244 arranged on top of the phase structure 202, this layer may also be arranged below the phase structure, thus between this structure and the first electrode 220. These modifications are also possible in the embodiment of FIGS. 2a and 2b.

The first liquid and the material of the substrate wherein a phase structure, grating structure or a non-periodical structure, is configured may be chosen such that they have the same refractive index. In the discrete state of the unit wherein the first liquid is positioned in optically active portion of the unit and fills the phase structure, this structure does no longer introduce phase shifts in an incident beam. In the second discrete state of the unit wherein the second medium fills the phase structure, this structure introduces phase shift in the incident beam. In this way the function of the phase structure can be switched off and on by moving the polar liquid in and out the central portion of a unit comprising such a phase structure. This embodiment of the switchable optical unit can be used, for example, in an optical head for scanning an optical record carrier wherein a read beam should be split into three beams, whilst a writing beam, which may have the same wavelength as the reading beam, should not be split.

A phase structure shown in FIGS. 2a and 2b and in FIGS. 3a and 3b may be configured on its own substrate and form a stand-alone element. However such a phase structure may also be arranged on, i.e. integrated with, the surface of an element, for example a lens element, that is already present in an optical system. In this way the number of surfaces to be passed by a radiation beam travelling through the system can be limited.

The nature of the present switchable optical unit allows incorporating in this unit two different phase structures, grating structures or non-periodical structures, whereby each of these structure is switched by its own, first electrode. For FIGS. 2a and 2b this means that a grating structure is also configured in substrate 76 and for FIGS. 3a and 3b this means that a phase structure is also configured in substrate 207. Each of the phase structures of such a switchable unit can be switched in two discrete states, independently of the state of the other phase structure, by switching the voltage supplied to the first electrode associated with this phase structure. Thereby an optimum use is made of the possibility to activate, by means of an appropriate electronic switching system, the two first electrodes independently of each other to enlarge the capability of the switchable optical unit. Such a unit can be switched in four discrete states.

A lens system wherein the invention is implemented such as the lens system of FIGS. 1a and 1b may be very small and is suitable for use in a miniature camera. The principle of such a camera is shown in FIG. 4. The camera 300 comprises a lens system 302 having an optical axis 304 and an image receiving unit 312 upon which the image, formed by the lens system of a scene at the left hand side of system 302, is formed. The unit 312 may be an opto-electronic sensor such as a CCD or a CMOS sensor, but also a photographic film. The camera may be a still-picture camera or a video camera. The lens system may comprise two double convex lens elements 306 and 308 and a liquid chamber 310 comprising a first liquid and a second medium (not shown) and a liquid switching system. This unit may be similar to that shown in FIGS. 1a and 1b. Depending on the required capabilities, the lens system may be extended with one or more solid lens elements.

FIG. 5 shows an example of a hand-held apparatus wherein the camera, wherein the invention is implemented, is used. The apparatus is a mobile phone 320 shown in front view in FIG. 5. The mobile phone has a microphone 322, which inputs the user's voice as data, a loudspeaker 324, which outputs the voice of a communicating partner and an antenna 326, which transmits and receives the communicating waves. The mobile phone further comprises an input dial 328, by means of which the user inputs data, such as a phone number to be dialed, and a display 330, for example a liquid crystal display panel. This panel may be used to display a photograph of the communicating partner of the user or to display data and graphics. For processing the input data and the received data, a data processing unit (not shown) is included in the mobile phone.

The mobile phone 320 is provided with a miniature camera 332 comprising a lens system as described herein before with respect to FIGS. 1a, 1b and FIG. 4. Of this camera only the front surface of the first lens element is shown in FIG. 5. The other elements of the camera, i.e the liquid chamber of the liquid switching system, the other lens element(s) and the image sensor may be arranged along a line perpendicular to the front surface of the phone, i.e. in the direction perpendicular to the plane of drawing of FIG. 5, if the dimension of the phone in this direction is large enough. The optical system of the camera may be provided with a folding mirror so that a substantial portion of the optical path of the camera can be arranged parallel to the front surface of the phone, which may then be relatively thin.

Usually, lens systems in miniature camera's for mobile phones have a fixed focus and are of the Tele type, which means that these systems form a sharp image on the sensor of an object or scene, which is at a large distance from the camera. By including a lens system provided with a liquid switching system according the invention, the camera can be switched between Tele mode and Macro mode so that also an object or scene at a short distance from the camera can be sharply imaged on the sensor.

Other hand-held apparatus wherein the invention may be implemented is a personal digital assistant PDA, a pocket computer and an electronic toy, wherein miniature cameras are built-in.

The invention may also be used in non-built-in cameras, like cameras for desktop computers, cameras for intercom systems and pocket-sized and other-size cameras, for example digital cameras. The camera may be a still-picture (photo) camera or a video camera. For the invention it is irrelevant whether the camera uses a film or an electronic sensor.

FIG. 6 schematically shows an optical head 360 for scanning, for the purpose of reading and/or writing data, an information layer of an optical record carrier 350, in this example a disc.

The optical record carrier comprises a transparent layer 352, on one side of which at least one information layer 354 is arranged. The record carrier may comprise a number of information layers arranged at different depths within the record carrier. The side of the information layer facing away from the transparent layer is protected from environmental influences by a protection layer 356. The side of the transparent layer facing the optical head is the disc entrance surface 358. The transparent layer 352 acts as a substrate for the optical record carrier by providing mechanical support for the information layer or layers. Alternatively, the transparent layer may have the sole function of protecting the information layer 354, while the mechanical support is provided by a layer on the other side of the information layer, for instance by the protection layer 4 or by a further information layer and transparent layer connected to the uppermost information layer.

Information may be stored in the information layer 354, or information layers of the optical record carrier in the form of optically detectable marks arranged in substantially parallel, concentric or spiral tracks, not indicated in FIG. 6. The marks may be in any optically readable form, i.e. in the forms of pits, or areas with a reflection coefficient or a direction of magnetisation different from their surroundings, or a combination of these forms.

The optical head 360 includes a radiation source unit 362, preferably a semiconductor laser unit, which in its most simple form emits one radiation beam 364 of a given wavelength, corresponding to a given type of record carrier. The radiation beam is divergent and emitted towards a lens system. This lens system includes a collimator lens 366 and an objective lens 370 arranged along an optical axis 372. The objective lens is represented as a single lens element, but may comprise two or more lens elements depending on amongst others the size of the spot to be formed in the information layer 354. The collimator lens transforms the divergent beam 364 into a substantially collimated beam 374. The objective lens 370 transform the incident radiation beam 382 into a converging beam 376 having a selected numerical aperture (NA), which beam comes to a focal spot 380 in the information layer 354.

By rotating the record carrier around an axis (not shown) parallel to the plane of drawing of FIG. 6, a track can be scanned. By linear displacing the record carrier and the spot 380 in the radial direction of the optical record carrier all tracks of the information layer can be scanned.

For reading of the information plane use is made of beam radiation that is reflected by the record carrier. This radiation, which is denoted by reference numeral 390 travels along the same path back and part of it is reflected to a beam splitter 388 towards a radiation-sensitive detection unit 384. This radiation is converged by a second collimator lens 386. The detection unit converts the incident, information carrying radiation into electrical signals, from which data signals and control signals including focus error signals and tracking error signals can be derived. The error signals are used to adjust the axial position and the radial of the spot 380.

To keep the spot on the track to be scanned, usually a track servo system is used, which comprises a so-called three spots grating 392, i.e a grating that splits the beam 364 from the laser unit 362 into a main beam, which is used for scanning, and two auxiliary beams. The auxiliary beams are focused in the information layer to satellite spots, which, in the radial direction, are positioned at different sides of the main spot formed by the main beam. By comparing the signals obtained from the satellite spots it can be determined whether there is a deviation between the centre of the main spot and the centre line of the track to be scanned and measures can be taken to correct this.

Since for writing data substantially more radiation energy is needed than for reading date, it may be required for an optical head for writing and reading to have a three-spot grating in the radiation path only during reading. There is thus a need for a three-spot grating that can be switched on and off. To meet this need a switchable grating unit as shown in FIGS. 2a and 2b can replace a conventional three-spot grating.

Another aspect of a write and read optical head is that if the laser energy is switched from read level to write level and vice versa, the wavelength of the laser beam changes. Since a diffraction element present in an optical head, for example a three spot grating is sensitive for a shift of the wavelength of the beam, this result of such switching is that path of the write beam is different from that of the read beam. This problem can be solved by replacing the conventional diffraction grating by a switchable grating unit 392 having two discrete “on” states. This grating unit comprises a switchable liquid system described with respect to FIGS. 2a and 2b, which includes a first liquid having a refractive index different from that of the grating material. By an appropriate choice of refractive indices of the first liquid and the second medium it can be achieved that the beams of different wavelengths are diffracted in the same way by the switchable grating if this is switched in one of the two discrete states for one of the wavelengths and in the other state for the other wavelength.

Currently data can be stored in information layers of optical record carriers having different formats, such as compact discs (CDs), which are available, inter alia, as CD-A (CD-audio), CD-ROM (CD-read only memory), CD-R (CD recordable) and CD-RW (CD re-writable), and digital versatile discs (DVDs) in the same types as CDs. To avoid customers have to purchase different devices for reading or writing date from or to CD types or DVD types record carriers; it is desirable for a single optical head to be capable of scanning optical record carriers of different formats. The apparatus (player) comprising such an optical head is known as combi-player.

However this aim is not easy to accomplish as the different record carrier formats and the associated optical heads have different characteristics. For example, CDs are designed to be scanned with a laser beam having a wavelength of about 785 nm and a numerical aperture of 0.45. DVDs, on the other hand, are designed to be scanned with a laser beam having a wavelength in the region of 650 nm and a numerical aperture of 0.6 (for reading) and 0.65 (for writing).

The radiation source unit of the optical head for a combi player should emit a laser beam with a wavelength of 785 nm, which beam may be called a LD (low density) beam, and a laser beam having a wavelength of 650 nm, which beam may be called a HD (high density) beam, which beams should follow the same optical path through the optical head. In case both beams should be diffracted by, for example a three-spot, diffraction grating, for this purpose the diffraction grating described with respect to FIGS. 2a and 2b, which can be switched in two discrete states, can be used.

For generating laser beams having different wavelengths, for example 785 nm and 650 nm two separate diode lasers could be used. Currently duo lasers, which comprise two laser radiation-generating slits in one encapsulation are available, which are suitable for use in a combi head. Even if such a duo laser is used, the laser emitting slits are shifted with respect to each other and consequently the two laser beams would travel along different path through the combi head. This problem can be solved by arranging a diffraction element, which acts as a deflection element, close to the radiation source unit 362, which elements deflects one of the laser beams so that its axis coincides with that of the other laser beam. Such a deflection element should act only on one of the laser beams and should be switched off if the other laser beam is used. Depending on the design of the detection system 384, different detector elements are provided for the two beams or not, such a diffractive beam deflector may also be used at the side of the detection system. The switchable grating described with reference to FIGS. 2a and 2b and including a polar liquid having the same refractive index as the grating material is very suitable to be used in the combi head for this purpose.

Another and important aspect of a combi head is that the same objective system should focus the laser beams of substantially different wavelength to scanning spots having different sizes. Moreover, optical record carriers having different formats differ in the thickness of the transparent substrate 352, which typically acts as a protective layer of the disc and as a result the depth of the information layer from the entrance face of the record carrier varies with the record carrier format. For example, the information layer depth for DVDs is about 0.6 mm, whereas the information layer depth for CDs is about 1.2 mm. The spherical aberration incurred by the radiation beam traversing the protective layer is generally compensated in an objective lens of the optical head.

As a result of the different characteristics for different format record carriers, problems may result if it is attempted to read data, for example, from a record carrier with an optical head that has been optimised for another, different format record carrier. For example, large amount of spherical aberration and a non-negligible amount of spherochromatism can be caused if a record carrier of one format is read with an objective lens that has been optimised for a record carrier of another format.

The said problems become more manifest with the advent of the Blu-Ray™ record carrier, which has recently been announced following the advent of the blue diode laser that emit radiation at a significantly shorter wavelength, for example 405 nm, than the red diode laser used to read or write data from or to conventional DVDs. Because of its shorter wavelength, a blue laser beam can form a smaller scanning spot in the information layer of the record carrier, and hence the information marks and -tracks of A Blu-Ray™ record carriers can be more closely spaced than those of conventional DVDs. This means that Blu-Ray™ record carriers have a greater storage capacity than conventional DVDs. An optical head capable of scanning CD-, DVD- and Blu-Ray™ record carriers should comprise a 785 nm laser, a 650 nm laser and a 405 nm laser.

For scanning different format record carriers with a single objective lens system, it has been proposed to use a lens system that comprises in addition to refractive surfaces also a phase structure. International patent application WO 02/082437 describes such an objective lens, which phase structure comprises a plurality of phase elements of different heights which when viewed in profile are arranged as a series of steps. The different heights of the phase elements are related and arranged so as to produce a desired wavefront modification of the radiation beam of a specific wavelength for reading an information layer of a specific format. The phase structures involved are of a complex nature, the phase elements having a large range of different heights. Such phase structures are difficult to design and manufacture to a level at which high optical efficiency for each wavelength is achieved. Moreover they are expensive to manufacture, which renders an objective lens system with such a phase structure too expensive for a consumer product.

According to the present invention a wavefront modifier 368 in the form of the switchable phase structure described with reference to FIGS. 3a and 3b can be combined with a conventional type of objective lens system 370 to obtain a single objective system that is suitable for scanning record carriers of two or three different kinds. Since it is switchable this phase structure is provided with an extra degree of design freedom so that the phase structure becomes simpler than a conventional phase structure with the same functionality. The freedom of design is further enlarged if the switchable phase structure unit comprises more than one phase structure and the different phase structures can be switched independently from each other as described with respect to FIGS. 3a and 3b.

Dependent on its purpose the phase structure of the wavefront modifier may be a periodic or a non-periodic structure. For different embodiments of the phase structure itself and the capabilities of a switchable phase structure, reference is made to the previous filed unpublished PCT patent application IB2003/004030 which, with respects to these aspects, is incorporated herewith by reference. The switchable grating unit of the previous patent application differs from the present one in that a fluid switching system is used wherein the fluid chamber forms the optically active portion of the unit and for moving fluids to and from the chamber an external guide is used. In the fluid switching system of the present invention the optically active portion of the unit forms only a portion of the fluid chamber and the fluids always remain in this chamber, which makes the switchable phase structure unit considerably simpler and enlarges its practical applications.

Instead of in a separate wavefront modifier (368) the switchable phase structure may also be incorporated in the refractive lens system, which means that one or more phase structures are integrated with one or more of the refractive surfaces of the lens system.

In addition to the applications described herein above, the invention may be used, generally, in all optical systems, being refractive or diffractive or a combination of these, wherein switching of optical behaviour, for example optical power, is required to enlarge the capabilities of such systems. In general, the invention may also be used in optical systems, which can be designed and manufactured if elements of these can be switched into two or more discrete states.

1. A switchable optical unit (1; 50; 200) capable of controlling a beam of radiation (b) passing through an optically active portion (8; 108) of the unit, which unit comprises a chamber (10; 110) and an electrically conductive liquid (18; 118; 218) contained in the chamber and having an index of refraction different from that of its surroundings, the chamber being provided with an electrode configuration (20,22,24,28; 120,122,124,128; 220,222) wherein application of a voltage (V), from a voltage control system (30,32,34,36,38,40,41,42; 130,132,134,136,138,140,141,142) to electrodes causes movement of the said liquid, characterized in that the electrode configuration comprises a pair of first, central, electrodes (20,22; 120,122; 220,222) fixed to the inner walls (12,14) of the chamber at the position of the optically active portion (8; 108), second electrode means (24; 124) fixed to the inner walls of the chamber at positions outside the optically active portion and a third electrode (28; 128) in contact with the conductive liquid and continuously connected to a first output (32; 132) of a voltage source (30; 130), a second output (34; 134) of which is connected in a first mode to at least one of the first electrodes and in a second mode to the second electrode means.

2. A switchable optical unit as claimed in claim 1, characterized in that the second electrode means (24; 124) is constituted by one annular electrode having a U-shaped cross-section.

3. A switchable optical unit as claimed in claim 1 or 2, characterized in that the interior wall (12,14) of the chamber facing the liquid is coated with an insulating hydrophobic layer (44; 144).

4. A switchable optical unit as claimed in claim 1, 2 or 3, characterized in that the chamber comprises a medium (19: 119; 219) which has an index of refraction different from that of the conductive liquid (18; 118; 219).

5. A switchable optical unit as claimed in claim 4, characterized in that the medium (19; 119; 219) is a liquid.

6. A switchable optical unit as claimed in claim 4, characterized in that the medium (19; 119; 229) is a gas.

7. A switchable optical unit as claimed in claim 1, 2 or 3, characterized in that the liquid-less portion of the chamber (10; 110; 210) is at vacuum.

8. A switchable optical unit as claimed in any one of claims 1-7, comprising at least one lens element (2, 4) characterized in that at least one chamber wall (12, 14) situated in the optically active portion (8) is constituted by a refractive lens surface.

9. A switchable optical unit as claimed in claim 8, characterized in that each of two opposite chamber walls (12, 14) situated in the optically active portion (8) is constituted by a refractive lens surface.

10. A switchable optical unit as claimed in claim 8 or 9, characterized in that at least one of the refractive lens surfaces (12,14,46,48) is an aspherical surface.

11. A switchable optical unit as claimed in any one of claims 1-10, characterized in that at least one chamber wall (56; 78) situated in the optical active portion (108) is provided with a phase structure (58,60; 202).

12. A switchable optical unit as claimed in claim 11, characterized in that the phase structure is a non-periodical structure (202), which renders the unit to a wavefront-modifying unit.

13. A switchable optical unit as claimed in claim 11, characterized in that the phase structure is a periodical structure (58,60).

14. A switchable optical unit as claimed in any one of claims 1-13, characterized in that the voltage control system (30,32,34,36,38,40,41,42; 32,134,136,138,140,141,142) is arranged to supply a voltage to the first electrodes (20,22; 120,122; 220,222) individually.

15. A switchable optical unit as claimed in any one of claims 1-14, characterized in that the index of refraction of the electrically conductive liquid (18; 118; 218) is equal to that of the optically relevant material of the chamber wall (12,14; 112,114).

16. An optical camera (300) including a controllable lens system, characterized in that the lens system (1; 302) comprises a switchable optical unit as claimed in any one of claims 1-10.

17. A hand-held apparatus including an optical camera (300) as claimed in claim 16.

18. An optical head (360) for scanning an information layer (354) and comprising a radiation source unit (362) for supplying a scanning beam (364, 374), an objective system (370) for focusing the scanning beam (374) to a scanning spot (380) in the information layer and a radiation-sensitive detection unit (384) for converting scanning beam radiation (390) from the information layer in electrical signals, the radiation source being switchable to emit a read beam and a write beam respectively, characterized in that it comprises a diffraction element (392) for both the read beam and the write beam in the form of a switchable grating unit (50) as claimed in claim 13.

19. An optical head (360) for scanning an information layer (354) and comprising a radiation source unit (362) for supplying a scanning beam (364,374) an objective system (370) for focusing the scanning beam (374) to a scanning spot (380) in the information layer (354) and a radiation-sensitive detection unit (384) for converting scanning beam radiation (390) from the information layer in electrical signals, the radiation source being switchable to emit a read beam and a write beam respectively, characterized in that it comprises a diffraction element (392) for the read beam only in the form of a switchable grating unit (50) as claimed in claim 15.

20. An optical head (360) for scanning an information layer (354) and comprising a radiation source unit (362) for supplying a scanning beam (364,374), an objective system (370) for focusing the scanning beam (374) to a scanning spot (380) in the information layer and a radiation sensitive detection unit (384) for converting scanning beam radiation (390) from the information layer in electrical signals, the radiation source unit emitting at least two scanning beams of different wavelengths for scanning at least two information planes of different formats, characterized in that it comprises a beam deflecting element in the form of a switchable phase structure (50) as claimed in claim 15 to align the axis of the at least two beams having different wavelengths.

21. An optical head (360) for scanning an information layer (354) and comprising a radiation source unit (362) for supplying a scanning beam (364,374), an objective system (370) for focusing the scanning beam (374) to a scanning spot (380) in the information layer and a radiation-sensitive detection unit (384) for converting scanning beam radiation (390) from the information layer in electrical signals, the radiation source emitting at least two scanning beams of different wavelengths for scanning at least two information planes of different formats, characterized in that it comprises a three-spot grating (392) in the form of a switchable phase structure (50) unit as claimed in claim 13.

22. An optical head (360) for scanning an information layer (354) and comprising a radiation source unit (362) for supplying a scanning beam (364,374), an objective system (370) for converging the scanning beam (374) to a scanning spot (380) in the information layer and a radiation-sensitive detection unit (384) for converting scanning beam radiation (390) from the information layer in electrical signals, the radiation source emitting at least two scanning beams of different wavelengths for scanning at least two information planes of different formats, characterized in that the objective system comprises in addition to a refractive lens system (370) a wavefront-modifying unit (368) in the form of a switchable phase structure unit (50; 200) as claimed in claims 13, 14, 15 or 16.

23. An optical head (360) as claimed in claim 22, characterized in that the wavefront-modifying unit (50; 200) is incorporated in the refractive lens system (370).
